(19) United States
(12) Patent Application Publication
(10) Pub. No.: US 2022/0067696 A1
(43) Pub. Date: Mar. 3, 2022

(54) METHOD AND SYSTEM FOR LINKING QR PAY

(71) Applicant: Jongjin LIM, Seoul (KR)

(72) Inventor: Jongjin LIM, Seoul (KR)

(21) Appl. No.: 17/423,726

(22) PCT Filed: Jan. 18, 2020
(86) PCT No.: PCT/KR2020/000901

§ 371 Date: Jul. 16, 2021

(30) Foreign Application Priority Data
Jan. 18, 2019 (KR) 10-2019-0007199
Jan. 19, 2019 (KR) 10-2019-0007212
Jan. 26, 2019 (KR) 10-2019-0010219
Feb. 2, 2019 (KR) 10-2019-0014151
Feb. 23, 2019 (KR) 10-2019-0021491
Feb. 23, 2019 (KR) 10-2019-0021492
Mar. 12, 2019 (KR) 10-2019-0028452
Mar. 13, 2019 (KR) 10-2019-0029017
Mar. 16, 2019 (KR) 10-2019-0030222
Mar. 16, 2019 (KR) 10-2019-0030223
May 31, 2019 (KR) 10-2019-0064972
Jun. 29, 2019 (KR) 10-2019-0078420
Oct. 5, 2019 (KR) 10-2019-0123478
Oct. 25, 2019 (KR) 10-2019-0134150
Nov. 28, 2019 (KR) 10-2019-0156203
Jan. 18, 2020 (KR) 10-2020-0006934

(51) Int. Cl. G06Q 20/32; G06Q 20/12; G06Q 20/20; G06Q 20/40

(52) U.S. Cl. CPC G06Q 20/3276; G06Q 20/3278; G06Q 20/4014; G06Q 20/20; G06Q 20/12

(57) ABSTRACT

The present invention relates to a method and a system for linking QR pay in which, instead of a user running a payment application, scanning a store QR code, and entering a payment amount, a linking system transmits a store QR code and a payment amount to a payment module, and the payment module processes the payment by received store QR code and payment amount, and then transmits the result of the payment to the linking system.

### TECHNICAL FIELD

The present invention relates to a method, a system, a service and a business model, which can link a shopping mall or store POS by simply modifying a payment app while maintaining the core functions of QR pay, which recognizes a store, authenticates a user, and processes payment.

That is, the present invention relates to a method and a system that can link a shopping mall or store POS by QR pay, in which a customer scans a store QR code and transmits the QR code and payment amount to a payment app from an outside instead of inputting the payment amount, and the payment app pays with the transmitted QR code and payment amount and transmits the result to the outside after payment.

In addition, the present invention relates to a method and a system that can link a shopping mall or store POS by QR pay, in which the QR code is transmitted to the linking server when the customer runs the payment app and scans the store QR code, order information in the payment waiting state is received from the linking server, and the result is transmitted after payment so that the payment result is received at the POS.

In addition, the present invention relates to a service and a business model that implement the above.

### BACKGROUND ART

Recently, QR pay, which scans a QR code provided in a store with a smartphone app, and inputs the payment amount, is widely used.

### DISCLOSURE

### Technical Problem

However, the QR pay service does not link with a shopping mall or store POS.

Therefore, it is difficult to use the QR pay in online shopping malls.

It is inconvenient because the customer has to input the payment amount directly in the offline store. In addition, it is very inconvenient because the store employee has to visually check whether the payment is made and the amount of payment through the customer's smartphone screen, QR pay app screen or QR pay server, and POS and QR pay must be managed separately.

### Technical Solution

The present invention provides a method, a system, a service and a business model, which can link a shopping mall or store POS by simply modifying a payment app while maintaining the core functions of QR pay, which recognizes a store, authenticates a user, and processes payment.

That is, the present invention provides a method and a system that can link a shopping mall or store POS by QR pay, in which a customer scans a store QR code and transmits the QR code and payment amount to a payment app from an outside instead of inputting the payment amount, and the payment app pays with the transmitted QR code and payment amount and transmits the result to the outside after payment.

In addition, the present invention provides a method and a system that can link a shopping mall or store POS by QR pay, in which the QR code is transmitted to the linking server when the customer runs the payment app and scans the store QR code, order information in the payment waiting state is received from the linking server, and the result is transmitted after payment so that the payment result is received at the POS.

In addition, the present invention relates to a service and a business model that implement the above.

### Advantageous Effects

According to the present invention, it is convenient because it is not only possible to pay with QR pay at online shopping malls and a user does not required to input the payment amount. In addition, it is very convenient because there is no need to visually check every payment result in offline stores, and all management can be done at the POS.

### DESCRIPTION OF DRAWINGS

FIG. 1 is a diagram and a flowchart illustrating an example of a basic system configuration according to the present invention.

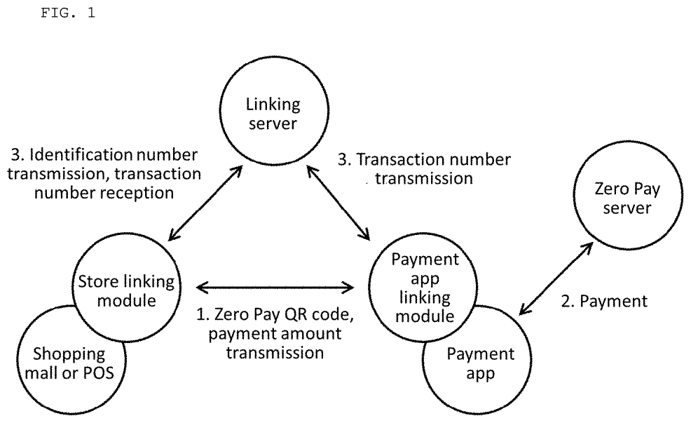

FIG. 2 is a view illustrating an example of the current QR Pay payment screen.

FIG. 3 is a flowchart illustrating an example of payment in an Internet shopping mall according to the present invention.

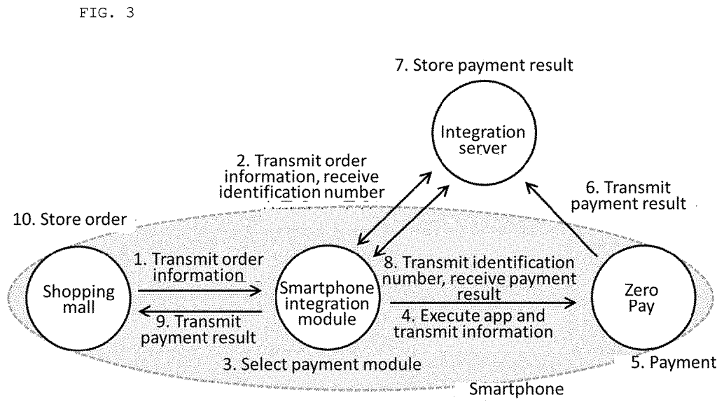

FIG. 4 is a view illustrating an example of a payment app selection screen.

FIG. 5 is a flowchart illustrating an example of payment in a PC Internet shopping mall and POS according to the present invention.

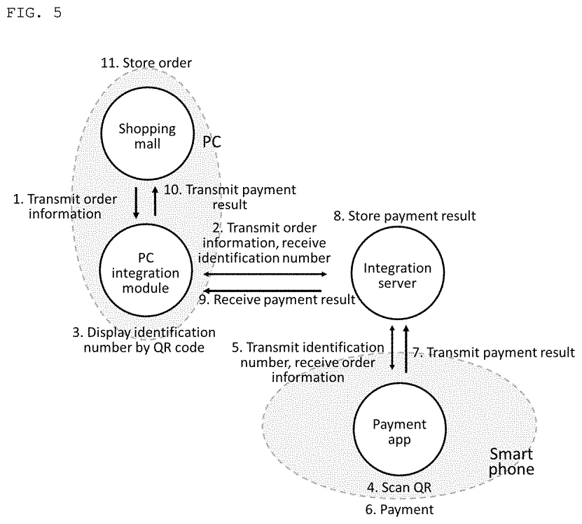

FIG. 6 is a view illustrating an example of a screen on which information required for payment is displayed as a QR code.

FIG. 7 is a view illustrating an example of a screen in which information required for payment is transmitted through SMS.

FIG. 8 is a flowchart illustrating an example of payment by scanning a store QR code according to the present invention.

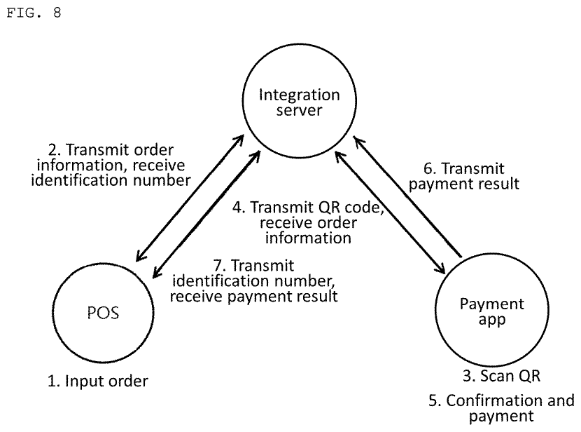

FIG. 9 is a view illustrating an example of an order selection screen when there are several orders in a payment waiting state when scanning a shop QR code.

FIG. 10 is a view illustrating an example of a screen for inputting a serial number after scanning a shop QR code.

FIG. 11 is a view illustrating an example of a QR code generation screen when a QR code is assigned to each POS.

FIG. 12 is a view illustrating an example of a screen for inputting a POS number after scanning a shop QR code.

FIG. 13 is a view illustrating an example of a screen in which a store employee inputs a payment amount in a separate app and receives a result when the POS is not linked.

FIG. 14 is a flowchart illustrating an example of obtaining a shop QR code of a corresponding service from a QR code in a QR integrated service according to the present invention.

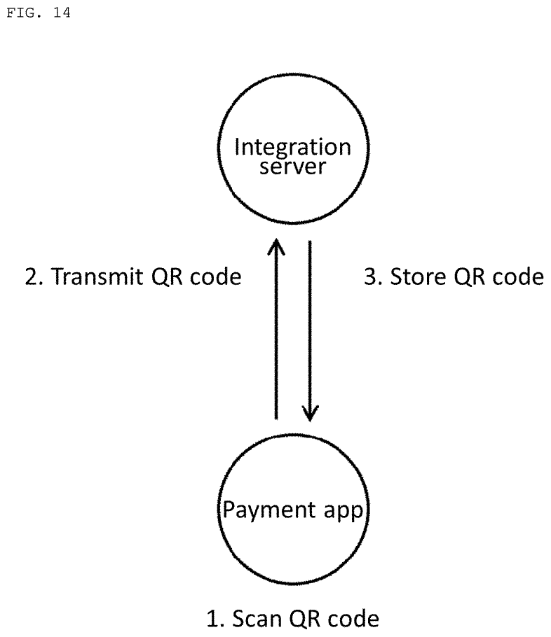

FIG. 15 is a view illustrating an example of a screen for selecting a payment service and a payment app in a QR integrated service.

FIG. 16 is a view illustrating a ZeroPay payment history inquiry screen.

FIG. 17 is a view illustrating an example of another system configuration according to the present invention.

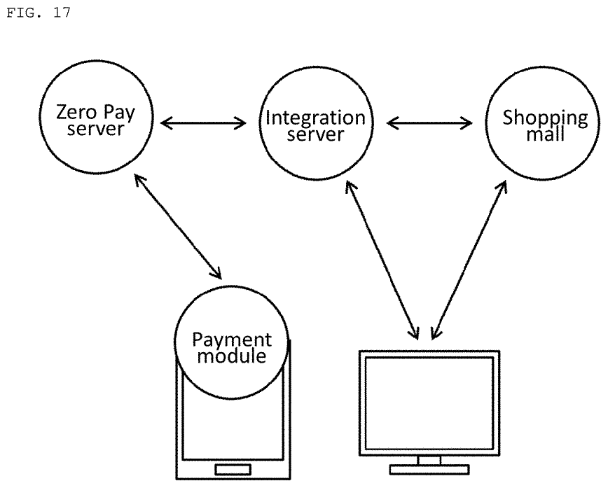

FIG. 18 is a flowchart illustrating an example of payment verification according to the present invention.

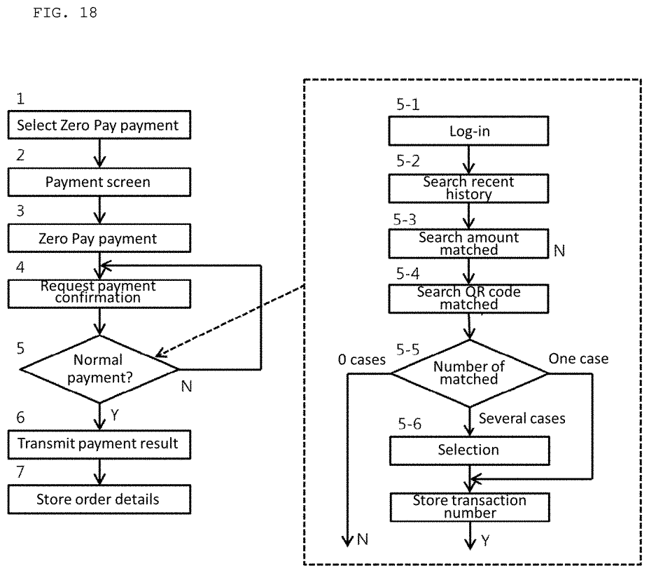

FIG. 19 is a view illustrating an example of an Internet shopping mall payment screen according to the present invention.

FIG. 20 is a view illustrating an example of a transaction number input screen according to the present invention.

FIG. 21 is a view illustrating an example of a transaction selection screen according to the present invention.

FIG. 22 is a flowchart illustrating cancellation processing according to the present invention.

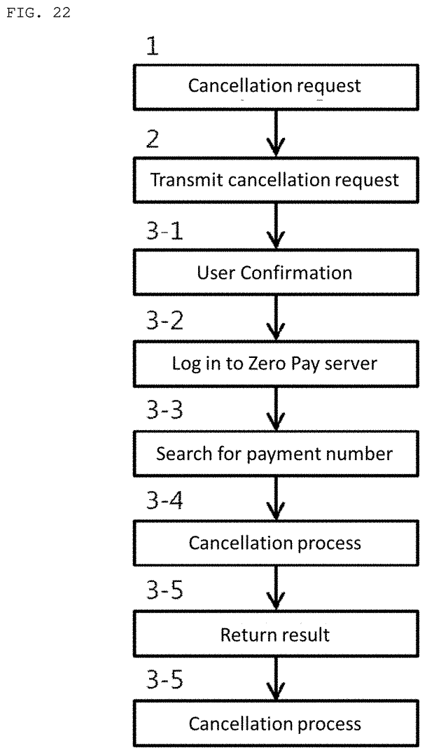

FIG. 23 is a flowchart illustrating an example of another payment verification according to the present invention.

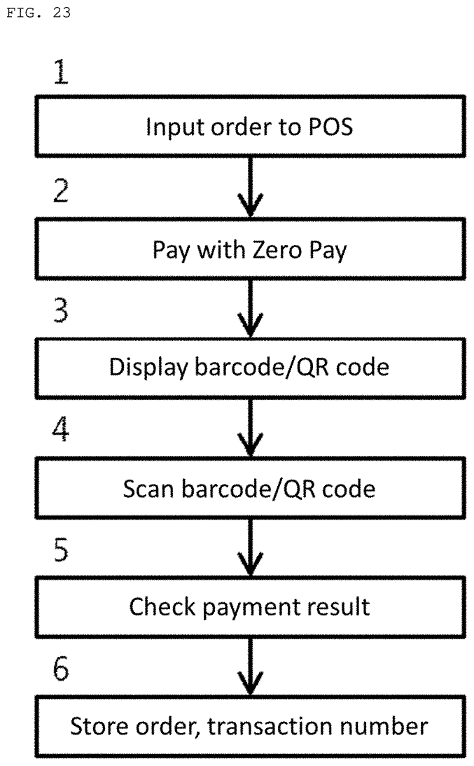

FIG. 24 is a view illustrating an example of a barcode display screen after payment according to the present invention.

### BEST MODE

In order to implement embodiments, first, a linking system links with each QR pay payment app as follows.

In step 1, a linking system transmits information such as QR pay, a QR code, a payment amount, and result receiving URL to a payment app.

When the payment app is in the form of a web page, the QR code and payment amount are transmitted to a web page as follows.

https://ZeroPay.naver.com/pay.jsp?qr=1-ZP-201811900011-M201811900000011-Zmlg&amount=10000&ordid=20190115000100&returl=https://qrpays.com/return.asp

Where ‘qr’ is a QR pay QR code of a corresponding store, ‘amount’ is a payment amount, ‘ordid’ is an integrated order number that identifies an order, and ‘returl’ is the URL for receiving the payment result.

In step 2, the payment app uses the transmitted QR code and payment amount to pay in the same scheme as in the related art.

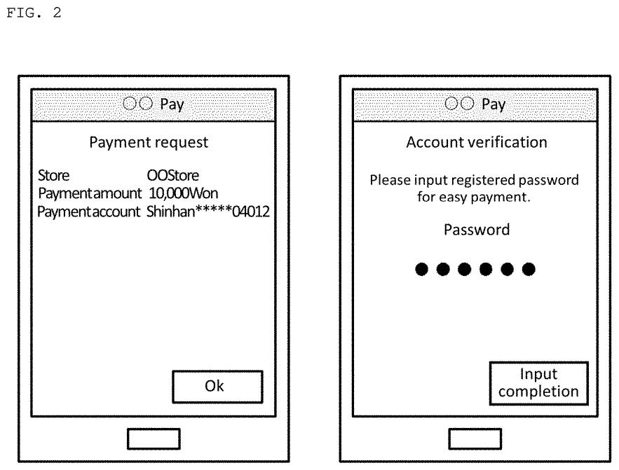

In step 2-1, the payment app shows the store name, payment amount and account information after searching for the store based on the QR code as shown in the first drawing of FIG. 2.

In this case, because the payment amount is already fixed, the customer does not need to input it, and the customer cannot modify the amount because the amount may change when the customer modifies the amount.

In step 2-2, when the customer clicks confirmation, a password input screen is displayed as shown in the second drawing of FIG. 2.

In step 2-3, the customer inputs the payment password and pays.

In step 2-4, the payment app proceeds with QR pay payment in the same scheme as in the related art.

In step 3, the payment app transmits the transaction number to the linking system after payment.

In the case of a web page call scheme, information may be transmitted to the integration server through the retURL specified in step 1 as follows.

https://qrpays.com/return.asp?retcd-OK&acid-PPG1900115116&ordid=20190115000100

where ‘retcd’ is a payment result code, ‘acid’ is a QR pay transaction number, and ‘ordid; is an integrated order number transmitted in step 1.

### MODE FOR INVENTION

Recently, QR pay, which scans a QR code provided in a store with a smartphone app, and inputs the payment amount, is widely used.

However, the QR pay service does not link with a shopping mall or store POS.

Therefore, it is difficult to use the QR pay in online shopping malls.

It is inconvenient because the customer has to input the payment amount directly in the offline store. In addition, it is very inconvenient because the store employee has to visually check whether the payment is made and the amount of payment through the customer's smartphone screen, QR pay app screen or QR pay server, and POS and QR pay must be managed separately.

The present invention relates to a method, a system, a service and a business model, which can link a shopping mall or store POS by simply modifying a payment app while maintaining the core functions of QR pay, which recognizes a store, authenticates a user, and processes payment.

That is, the present invention provides a method and a system that can link a shopping mall or store POS by QR pay, in which a customer scans a store QR code and transmits the QR code and payment amount to a payment app from an outside instead of inputting the payment amount, and the payment app pays with the transmitted QR code and payment amount and transmits the result to the outside after payment.

In addition, the present invention relates to a method and a system that can link a shopping mall or store POS by QR pay, in which the QR code is transmitted to the linking server when the customer runs the payment app and scans the store QR code, order information in the payment waiting state is received from the linking server, and the result is transmitted after payment so that the payment result is received at the POS.

In addition, the present invention relates to a service and a business model that implement the above.

In the description, the ZeroPay will be described as an example.

First of all, the ZeroPay QR code, which is a code for recognizing each store, includes the following string information.

1-ZP-201811900011-M201811900000011-Zmlg

Therefore, store information may be obtained by scanning a ZeroPay QR code image with a smartphone camera, but it is possible to save and transmit the string information.

Like Kakao Pay, the QR code of some QR pay includes a URL as follows.

https://qr.kakaopay.com/281006012000000000529148

Before the present description, terms are defined as follows.

A shopping mall is a company that sells goods or services over the Internet.

A store means a company or shop that sells goods or services offline.

In context, the store may collectively refer to an online shopping mall and an offline store.

A store order number refers to a number assigned to identify an order in a shopping mall or store.

The store order number may include letters in addition to numbers.

QR code refers to a QR code image or character string information described above.

If it is not separated like a QR code image or QR code string below, it is distinguished by context.

That is, scanning a QR code means a QR code image, otherwise it means a QR code string.

A transaction number means a unique number that identifies each ZeroPay payment case in the ZeroPay service.

A payment module or payment app means a module or app of a pay service and a bank including a ZeroPay payment function.

The payment module may be in the form of a web page, in the form of an app, or in the form of a module. Therefore, the payment module may be expressed by mixing the payment module and the payment app.

The linking module can be divided into a store linking module linking with shopping malls and POS and a payment app linking module interoperating with the ZeroPay payment app.

Store-linked modules such as PC-linked modules and POS-linked modules can be distinguished below.

A linked app means a link module in the form of an app.

Also, it is possible to use the linking module and interlocking app together.

The linking module means an integration module when using an integrated service, and a module within a shopping mall or POS when directly linking with the ZeroPay payment app in a shopping mall or POS.

The linking module may be in the form of a web page or an app.

The linking server is a server that saves and retrieves information required for payment and payment result information. When using an integrated service, it means an integration server. In the case of linking with the ZeroPay payment app directly from a shopping mall or POS, it means a shopping mall server or POS server.

The linking service refers to a service that provides linking between the shopping mall and POS and the ZeroPay payment app.

The linking system is a system for the linking service and includes a linking server and a linking module.

The integrated service refers to a service that provides linking between a plurality of shopping malls or POS and a plurality of payment modules.

The integration module is a module in the form of a web page, app or library that operates on a PC or smartphone for an integrated service. The integration module may also be divided into a store integration module that links with shopping malls and POS and an integrated payment app module that links with the ZeroPay payment app.

The integration app means an integration module in the form of an app.

In addition, the integration module and the integration app may be mixed and used.

The integration server means a server that saves and provides information necessary for the integrated service.

In this case, it is assumed that the server URL of the integrated service is https://qrpays.com.

The integrated system is a system for integrated services and includes an integration server and an integration module.

The integrated order number is a number assigned to identify an order in the integrated service and is expressed as an integrated order number to be distinguished from the order number.

Of course, the integrated order number may also include letters in addition to numbers.

In the case where the order number is not distinguished by the store order number or the integrated order number below, the order number that identifies the store's order is the store order number, and the order number that identifies the order in the integrated service is the integrated order number.

Each store is registered as a ZeroPay merchant in advance and is given a ZeroPay QR code.

In addition, in order to use the integrated service, each store subscribes to the integrated service as a member and registers a QR code.

In addition, the order state is defined as follows:

The payment waiting state means a state of waiting for the customer's payment after the order is saved in the linking server.

The payment completion state means a state in which the customer has completed payment.

The cancellation state refers to a status in which the customer cancels the order and has been canceled.

When the customer cancels the order, the order is canceled immediately so that the order does not remain in the waiting state for payment.

Although each shopping mall can directly call and process the payment module, it is inefficient for each shopping mall to develop each shopping mall because methods of calling and linking for each payment module may be different. In this case, the case of mainly using the integrated service will be described as an example.

For the service according to the present invention, the present invention includes:

an Internet shopping mall or offline store;

various pay services and bank payment modules each including a ZeroPay payment function; and

a linking system that provides linking between a shopping mall and

POS and a ZeroPay payment app.

In addition, the linking system includes:

a store linking module that links with shopping malls and POS;

a payment app linking module that links with the payment app; and

a linking server for saving and searching for information required for payment and payment results.

In order to implement the present invention, first, the linking module links with each ZeroPay payment module as follows.

In step 1, the linking module transmits information about the ZeroPay QR code and payment amount to the payment module.

In addition, a URL for receiving a payment result and information for identifying an order may be transmitted.

When the payment module is in the form of a web page, the QR code and payment amount are transmitted to the web page as follows.

https://ZeroPay.naver.com/pay.jsp?qr-1-ZP-201811900011-M201811900000011-Zmlg&amount-10000&ordid-20190115000100&returl-https://qrpays.com/return.asp

where ‘qr’ is the ZeroPay QR code of the corresponding store, ‘amount’ is the payment amount, ‘ordid’ is the integrated order number that identifies the order, and ‘returl’ is the URL for receiving the payment result.

In case of ActiveX version, it may be called as follows.

<script language=javascript>
var zp=ActiveXObject(‘naver.ZeroPay’);

ret=zp.pay(‘1-ZP-201811900011-M201811900000011-

Zmlg’, 10000);

</script>

In the case of the modal format, because the payment result may be returned immediately, there is no need to separately transmit the payment result receiving URL and the order number.

When the payment module is in the form of a smartphone app, the payment module is called according to the method provided by the smartphone OS such as Android or IOS.

Alternatively, as in the example below, it may be called in a common scheme like the URL scheme.

zpgp://ZeroPay.naver.com/pay.jsp?qr=1-ZP-201811900011-M201811900000011-Zmlg&amount=10000&ordid=20190115000100&returl=https://qrpays.com/return.asp

As described above, a parameter may be appended to the URL and transmitted, and may be transmitted according to a scheme provided by each OS.

In step 2, the payment module uses the transmitted QR code and payment amount to make a payment in the same scheme as in the related art.

In step 2-1, the payment module searches for the store based on the QR code, and then, displays the store name, payment amount and account information as shown in the first drawing of FIG. 2.

In this case, since the payment amount is already fixed, the customer does not need to input it, and the customer cannot modify the amount because the amount may change when the customer modifies the amount.

In step 2-2, when the customer clicks OK, a password input screen is displayed as shown in the second drawing of FIG.

Step 2-3, the customer inputs the payment password and pays.

Steps 2-4, the payment module proceeds with ZeroPay payment in the same way as before.

Step 3, the payment module transmits the transaction number to the linking module or linking server after payment.

In the case of a web page call method, information can be transmitted to the integration server using the returl specified in step 1 as follows.

https://qrpays.com/return.asp?retcd-OK&acid-PPG190011 5116&ordid-20190115000100

Here, retcd is the payment result code, acid is the ZeroPay transaction number, and ordid is the integrated order number transmitted in step 1.

Alternatively, the integrated service may provide a library-type module, and the payment app may call the module as follows.

ZeroPay zp=new ZeroPay( );

zp.SaveResult (“OK”, “20190120000001”, “PPG1900115116”);

Alternatively, in the case of a modal-type ActiveX module, it can be passed as a return value as follows.

retcd:OK

acid:PPG1900115116

ordid:20190115000100

Instead of plain text as described above, it can be returned in a format such as XML or JSON.

Alternatively, the processing result may be transmitted to the integration module according to the method provided by each OS.

Of course, when an error occurs, the error code and error content are transmitted.

Instead of the linking module transmitting information to the payment app in step 1 above, the payment app may transmit an integrated order number or QR code to the integration server, and receive information required for payment from the integration server.

Step 1-1, the payment app transmits the integrated order number or QR code to the integration server.

The integration server URL is called as follows.

https://qrpays.com/request.asp?ordid=20190115000100

https://qrpays.com/request.asp?qr=1-ZP-201811900011-M201811900000011-Zmlg

Alternatively, the integrated service may provide a library-type module, and the payment app may call the module as follows.

ZeroPay zp=new ZeroPay( );

zp.GetPrice(“20190120000001”);

Step 1-2, the integration server retrieves the order from the integrated order number or QR code in the method described below.

Steps 1-3, the integration server returns information required for payment as follows.

qr:1-ZP-201811900011-M201811900000011-Zmlg

ordid:20190115000100

amount:10000

returl:https://qrpays.com/return.asp

Instead of plain text as described above, it can be returned in a format such as XML or JSON.

In addition, the integrated service defines a method of linking with a shopping mall or POS.

In the case of a shopping mall, it can be linked in the following way.

First, it can be linked with a URL.

The shopping mall may request payment to the integration server as follows.

https://qrpays.com/pay.asp?id-hknets&ordid=123456&amount=10000& returl-https://www.xxxmall.com/pay/return.asp

where ‘id’ is the integrated service member ID of the shopping mall, ‘ordid’ is the order number of the shopping mall, ‘amount’ is the payment amount, and ‘returl’ is the payment result receiving URL.

Of course, even in the case of a credit card, other information necessary to process an order is transmitted in the POST method, but for convenience of explanation, only payment-related information is simply transmitted in the GET method as an example.

Instead of the integrated service member ID, you can also use the ZeroPay QR code like gr-1-ZP-201811900011-M20181190000001-Zmlg.

The integration server or the integration module may transmit the result to the shopping mall as follows.

https://www.xxxmall.com/pay/return.asp?retcd=OK&ordid=123456&acid=PPG1900115116

The ‘retcd’ is the payment result code, acid is the ZeroPay transaction number, and the ‘ordid’ is the shopping mall order number received from the shopping mall.

Second, you can use ActiveX.

The shopping mall can pass the payment request by calling ActiveX as follows.

<script language=javascript>

var qp=ActiveXObject (‘qrpays.pay’);

ret=qp.pay(“hknets”, “123456”, 10000);

</script>

Here, the first parameter is the integrated service member ID of the shopping mall, the second parameter is the shopping mall order number, and the third parameter is the payment amount.

The shopping mall may return a result as follows.

retcd:OK

acid:PPG1900115116

Where ‘retcd’ is the payment result code, and ‘acid’ is the ZeroPay transaction number.

In the method of returning the result as in the above example, the order can be identified in the POS without transmitting the order number, but the order number can be transmitted because it may be needed later when comparing data with the integration server.

Instead of plain text as described above, it can be returned in a format such as XML or JSON.

In the case of POS, it can be linked in the following way.

First, it can be linked with a URL.

The POS may forward the payment request as follows.

https://qrpays.com/pay.asp?id=hknets&ordid=123456&amount=10000

The POS can return the result by calling the URL as follows.

https://qrpays.com/result.asp?id-hknets&ordid=123456

Alternatively, when a payment request is made, the returned integrated order number may be transmitted and the result may be returned.

https://qrpays.com/result.asp?ordid=20190115000100

In the case of POS, if there is a server, an integration server or an integration module may transmit to the POS server as in the case of a shopping mall.

Second, the integrated service may provide a separate linking module.

The POS may forward the payment request as follows.

Set o=CreateObject(“ZeroPays.Pay”)

ret=o.Pay(“hknets”, “123456”, 10000)

The POS may receive the returned result as follows.

retcd:OK

acid:PPG1900115116

In addition, instead of plain text as described above, the result may be returned in a format of XML or JSON.

In addition, it may be linked in various schemes.

The present invention may be applied to an online shopping mall as follows.

Because the method of searching for a product in the shopping mall and moving to the payment screen is the same as in the related art, it will be omitted from this description, and a process of selecting ZeroPay payment and making payment screen by a customer will be described.

In step 1, the shopping mall payment page transmits the integrated service member ID, order number, payment amount, and payment result receiving URL to the integration module as described above.

In step 2, the integration server searches for member information, saves the received information in the case of a normal member, generates an integrated order number that can identify the corresponding order, and returns the integrated order number and the ZeroPay QR code of the corresponding shopping mall.

In step 2-1, the integration module transmits the received information to the integration server.

In step 2-2, the integration server searches for the ZeroPay QR code of the corresponding shopping mall.

In step 2-3, the integration server generates an integrated order number that can identify the corresponding order.

It is assumed that the generated integrated order number is ‘20190115000100’.

In step 2-4, the integration server saves information about the integrated order number, the integrated service member ID of the shopping mall, the shopping mall order number, the payment amount, and the like.

When the integration server directly transmits the payment result to the shopping mall, the payment result receiving URL is also saved.

In step 2-5, the integration server returns the ZeroPay QR code and the integrated order number.

In this case, the shopping mall name may be returned together to show the shopping mall name in step 3.

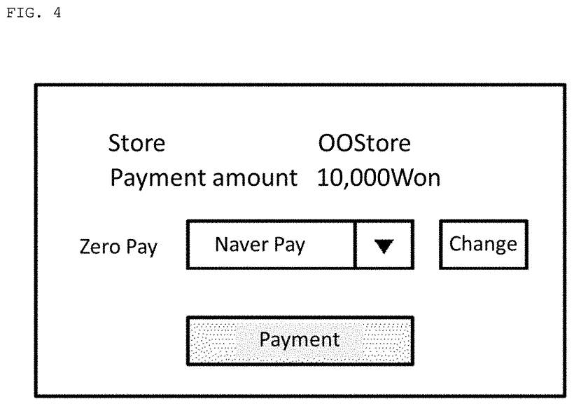

In step 3, the integration module shows a ZeroPay payment module selection screen as shown in FIG. 4, and the customer selects one of the ZeroPay payment modules and clicks payment.

Of course, the payment module may be selected on the shopping mall payment page and the payment module may be transmitted to the integration module from the shopping mall payment page. In this case, step 3 is omitted and step 4 is performed.

Because it is not common for customers to use several payment apps, it is possible to save the previously used payment module and show it as a default.

In step 4, the integration module executes the ZeroPay payment app as described above, and transmits the store QR code, payment amount, integrated order number, and result receiving URL.

In step 5, the ZeroPay payment app pays with the transmitted store QR code and payment amount.

In step 6, the ZeroPay payment app transmits the payment result including the ZeroPay transaction number to the integration server.

In step 7, the integration server searches for the order based on the integrated order number and saves the ZeroPay transaction number.

In step 8, the integration module transmits the integrated order number to the integration server, and receives the payment result from the integration server.

https://qrpays.com/result.asp?ordid-20190115000100

The integration module may periodically access to the integration server to receive the result, and may receive information from the integration server at the moment the customer clicks a button on the integration module after payment.

In step 8-1, the integration module transmits the integrated order number to the integration server.

In step 8-2, the integration server searches for the order based on the integrated order number.

In step 8-3, the integration server returns the payment result including the ZeroPay transaction number of the corresponding order.

In step 9, the integration module transmits the payment result including the shopping mall order number and transaction number to the shopping mall server as described above.

In step 10, the shopping mall transmits the ZeroPay transaction number and order details to the server after receiving the payment result, and the shopping mall server saves the transaction number and order details.

In step 8 described above, the integration server may transmit the payment result to the shopping mall server.

Since the QR code scanning function that is processed as in this example is not required, when a payment module that operates on a PC is made, the payment module may be interact as described above.

However, like ZeroPay, when there is a smartphone payment app without PC payment module, the information required for payment cannot be transmitted directly from the PC to the customer's smartphone app.

Even at POS, it is not possible to transmit the information required for payment directly to the customer's smartphone app.

However, it is possible to pay using the smartphone app on a PC or POS as follows.

In this case, the integration module is referred to as a module operating in a PC and a module operating in a smartphone, which are distinguished from each other.

In this case, the PC or POS must first transmit the integrated order number or all information required for payment to the smartphone linking module in the following manner.

First, the integrated order number may be transmitted as follows, and information required for payment may be received from the integrated order number.

The PC or POS linking module transmits the order information to the integration server as described above, and after receiving the returned integrated order number, transmits the integrated order number in a following form.

https://qrpays.com/request.asp?ordid-20190115000100

or

ordid:20190115000100

url:https://qrpays.com/request.asp

or when URL is fixed,

20190115000100

It is possible to transmit only the integrated order number such as 20190115000100.

After receiving the integrated order number, the smartphone linking module or payment app receives information required for payment as follows.

In step 1, the smartphone integration app or payment app transmits the integrated order number to the integration server.

https://qrpays.com/request.asp?ordid=20190115000100

In step 2, the integration server searches for the order and returns information required for payment.

In step 2-1, the integration server searches for the order based on the integrated order number.

In step 2-2, the integration server returns information about the ZeroPay QR code and payment amount of the store as follows.

qr:1-ZP-201811900011-M201811900000011-Zmlg

amount:10000

returl:https://qrpays.com/return.asp

Second, all information required for payment may be transmitted as follows.

https://qrpays.com/request.asp?qr-1-ZP-201811900011-M201811900000011-Zmlg&ordid-20190115000100&amount-10000&returl-https://qrpays.com/return.asp

or

qr:1-ZP-201811900011-M201811900000011-Zmlg

ordid:20190115000100

amount:10000

url:https://qrpays.com/request.asp

or when the URL is fixed,

qr:1-ZP-201811900011-M201811900000011-Zmlg

ordid:20190115000100

amount:10000

may be transmitted.

In this case, there is no need for the smartphone integration app or payment app to transmit the integrated order number to the integration server and receive information required for payment from the integration server.

The information may be transmitted through various media or various schemes as follows.

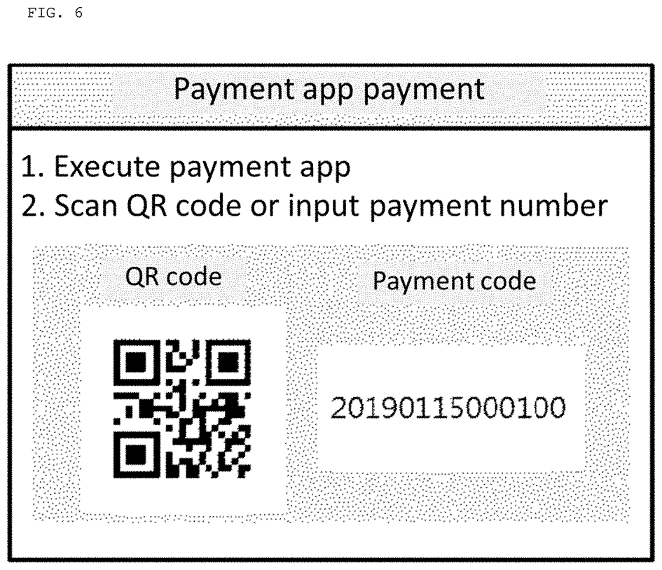

First, as shown in FIG. 6, the integrated order number may be transmitted by being displayed on the PC screen or POS customer monitor as a barcode or QR code.

Recently, most POS terminals use a PC, and there are many cases where, in addition to the monitor that the store staff sees, a monitor that allows customers to check the purchase history and amount is installed. The PC integration module installed in the POS displays a barcode or QR code on a monitor for a customer, thereby allowing the customer to execute the smartphone integration app or payment app and scan it.

In addition, as described above, only the integrated order number may be transmitted, and since the QR code may include a lot of information, all information required for payment may be transmitted.

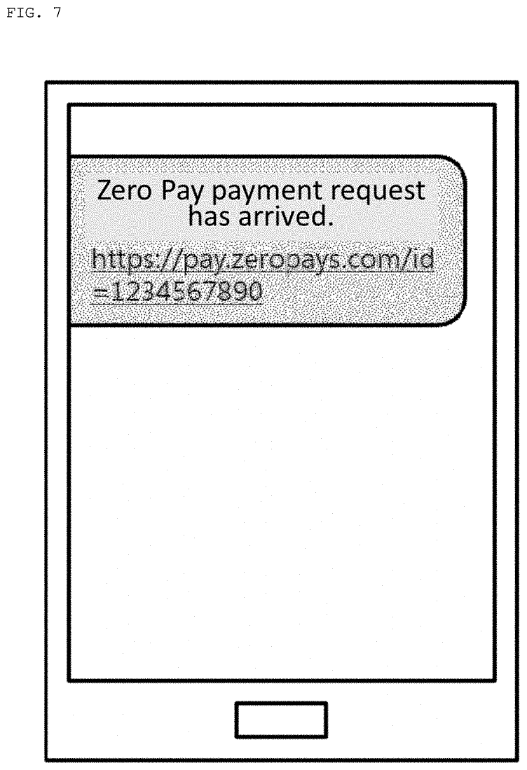

Second, as shown in FIG. 7, the URL may be transmitted to the customer's smartphone through a text message, a messenger or a push notification.

When ordering at the shopping mall, because the customer's mobile phone number is input, the order may be received from the shopping mall without the need to input it separately.

In an offline store, the customer asks for a mobile phone number, and the mobile phone number is transmitted to the integration server. Then, the integration server may also transmit to the customer's smartphone.

https://qrpays.com/request.asp?ordid=20190115000100

Or

https://qrpays.com/request.asp?qr-1-ZP-201811900011-M201811900000011-Zmlg&ordid-20190115000100&amount-10000&returl-https://qrpays.com/return.asp

After receiving the message, the customer touches the URL or push notification in the text or message of the smartphone.

When you touch the URL, you automatically go to the website, and the webpage can transmit the integrated order number or information required for payment to the integration module or payment app.

Third, the customer may be informed of the integrated order number, and the customer may execute the smartphone integration app or payment app and input the integrated order number.

In this case, because it is difficult to input a lot of information, it is used when the URL is fixed, and the integrated order number is transmitted.

In addition, a simple identification number may be used instead of the integrated order number.

Fourth, in the case of an offline store, when there is a terminal capable of communicating with a smartphone such as an NFC terminal in the store, it may be transmitted to the terminal.

When the integrated order number or all information required for payment is transmitted from the POS to the terminal, and the customer approaches the smartphone to the terminal after executing the integration app or payment app, the integration app or payment app may receive the integrated order number or all information required for payment from the terminal.

Only the integrated order number may be transmitted, and all information required for payment may be transmitted.

In the description below, the case of displaying the integrated order number in the form of a QR code on the screen and scanning the QR code with a payment app will be described as an example.

In step 1, the shopping mall payment page transmits the integrated service member ID, order number, payment amount, and payment result receiving URL to the PC integration module.

In step 2, the PC integration module transmits the received information to the integration server, which saves the information and issues and returns the integrated order number.

In step 3, the PC integration module shows the integrated order number as a QR code on the PC screen as shown in FIG. 6.

Of course, it may also be displayed as a number so that the customer inputs it directly.

In step 4, the customer runs the smartphone payment app and scans the QR code on the PC screen.

Of course, the customer may look at the numbers and inputs the numbers directly.

In step 5, the payment app transmits the integrated order number to the integration server, and receives information about the store QR code and payment amount from the integration server.

In step 6, the payment app pays based on the received store QR code and payment amount.

In step 7, the payment app transmits the payment result to the integration server.

In step 8, the integration server searches for the order based on the integrated order number and saves the transaction number.

In step 9, the PC integration module receives the payment result from the integration server.

In step 10, the PC integration module transmits the payment result to the shopping mall server.

In step 11, the shopping mall payment page receives the ZeroPay transaction number and transmits the ZeroPay transaction number and order details to the server. Then, the shopping mall server saves the transaction number and order details.

The POS may process it in the same manner as in the PC shopping mall.

In step 1, when a store employee inputs an order to the POS and clicks the ZeroPay payment button, the POS calls the integration module as follows and transmits the integrated service member ID, order number and payment amount to the POS integration module.

In step 2, the POS integration module transmits the received information to the integration server, which saves the information and then issues and returns the integrated order number.

In step 3, the POS integration module shows the integrated order number as a QR code on the monitor for POS customers.

In step 4, the customer runs the smartphone payment app and scans the QR code on the POS screen.

In step 5, the payment app integration module transmits the integrated order number to the integration server, and receives information about the store QR code and payment amount from the integration server.

In step 6, the payment app pays based on the received store QR code and payment amount.

In step 7, the payment app integration module transmits the payment result to the integration server.

In step 8, the integration server searches for the order based on the integrated order number and saves the transaction number.

In step 9, when the store employee presses the confirmation key on the POS, the POS integration module transmits the integrated order number and receives the payment result from the integration server.

In step 10, the POS integration module returns the payment result.

In step 11, the POS saves the transaction number and order details after receiving the ZeroPay transaction number.

The information required for payment may be received from the store QR code as follows.

In general, QR Pay issues a QR code for each store when a single merchant has multiple stores.

In an online shopping mall, orders and payment may occur simultaneously, whereas in an offline store, after payment for one order is completed, the next order is processed. When there is only one POS in one store or one store, that is, there is only one POS using one QR code, the order may be identified simply by scanning the store QR code as follows.

In step 1, the store employee inputs the order into the POS and clicks the confirm button.

In step 2, the POS transmits the store QR code and order details to the integration server, and receives the integrated order number.

In this case, the integration server saves the store QR code in the order information.

In step 3, the customer runs the payment app and scans the store QR code.

In step 4, the payment app transmits the store QR code to the integration server, and receives the integrated order number and information required for payment from the integration server.

In step 4-1, the payment app transmits the store QR code to the integration server.

In step 4-2, the integration server searches for an order in the payment waiting state among the orders including the transmitted QR code.

There is only one POS using one store's QR code, and the POS performs payment sequentially, so there is only one order waiting for payment at that time.

However, in order to prevent a case in which an order that is still in a payment waiting state among previously transmitted orders is detected, only orders transmitted within a specified time, such as within 1 minute from the current time, may be detected.

In step 4-3, the integration server returns the integrated order number and payment amount.

In step 5, the payment app pays with the store QR code and payment amount.

Of course, if detailed order information in addition to the payment amount are transmitted to the server, received and displayed, the customer may check once more whether the order is his or her own.

In step 6, the payment app transmits the payment result to the integration server.

In step 7, the integration server searches for an order based on the integrated order number, and saves the payment result.

In this case, the order state is changed to the payment completed state so that the order does not remain in the payment waiting state.

Thereafter, the POS receives the payment result in the same manner as above, and saves the order.

When several POSs share the integrated service ID in such a case that there are plural stores and each store uses its own QR code, but subscribe to a single integrated service ID, the QR code is required to be saved in the order information for the search in step 4 as described above. However, in the case of using one integrated service ID for each POS, the QR code may be processed in step 4-2 as follows without saving the QR code in step 2 above.

In step 4-2-1, the integration server searches for the store's integrated service ID based on the store's QR code.

In step 4-2-2, the integration server searches for orders which are in the payment-waiting state among the orders of the corresponding store.

When the integration server saves the order and the customer cancels the order without payment, the POS transmits the integrated order number to the integration server, and the integration server cancels the corresponding order so that the order is prevented from being detected in step 4 later.

There may be several POSs, and the POSs may input orders at the same time.

That is, when a single QR code is shared by several POSs, several orders may be saved with one QR code at the same time.

In this case, when the payment app transmits a QR code, the integration server may distinguish the customer's order from among the multiple orders waiting for payment including the QR code.

There may be several schemes to do this:

First, the integration server may search for the most recent case which is in the payment waiting state, among the orders including the transmitted QR code, and returns the integrated order number and the payment amount. Then, the customer may select it.

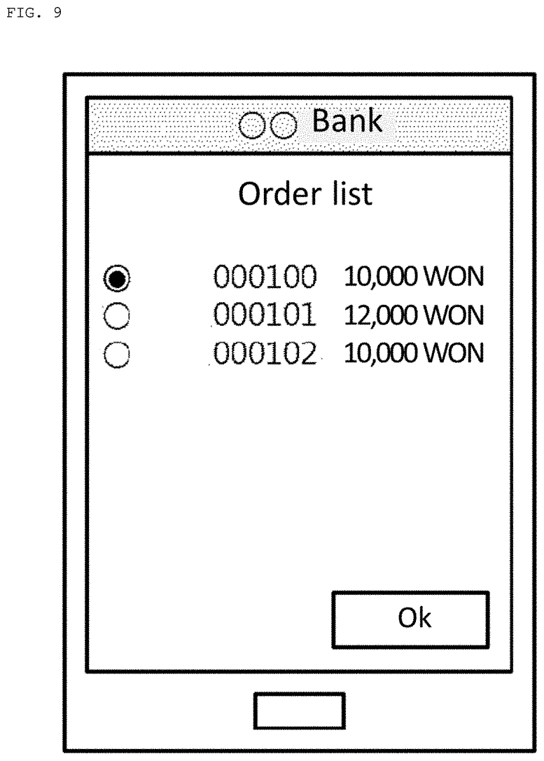

That is, in the step 4, the integration server returns the integrated order numbers and payment amounts of all orders that are in the payment waiting state, among the orders including the transmitted QR code, and in the case of multiple cases, the payment app shows a list of orders after receiving the order information as shown in FIG. 9, and the customer selects and pays.

In general, because the store employee informs the payment amount after inputting the order into the POS, when the payment amounts for orders are different from each other, it is easy to be selected.

When there are several cases of which the payment amounts are the same, the store employee informs of the integrated order number, and the customer selects the corresponding integrated order number.

In addition, in order to prevent the customer from selecting an order with a different amount, when a payment result is requested from the POS, the integration server returns the payment result including the payment amount, and the POS may check whether the payment amount is the same.

Second, the integration server may classify orders by assigning a serial number to each order.

That is, in step 2 above, the order details are transmitted to the integration server as follows, and the serial number is received.

In step 2-1, the POS transmits the store QR code and payment amount to the integration server.

In step 2-2, the integration server generates an integrated order number and a simple serial number.

The serial number is a number for identifying the corresponding order among the orders in the payment waiting state, and the serial number for the order generated with the same QR code is generated with 2 or 3 digits.

That is, when there are plural POSs in a store, using a single QR code, and using a two-digit serial number, even when the serial number of the order input from one POS is ‘1’, and then, an order is transmitted from a POS in the store, serial number 2 is assigned. Then, the serial number is increased sequentially, and when the serial number reaches 99, the serial number is changed to ‘0’ or ‘1’ again.

In general, one store uses one QR code, but the number of orders that may occur simultaneously in one store is limited.

That is, when there are 3 POSs in one store, the maximum number of orders that can occur at the same time is ‘3’, and even though it is possible to input and transmit the next customer's order before payment, about 6 orders are possible.

Therefore, it is possible to identify an order waiting for payment with a one-digit serial number for one QR code.

However, in the case of using one digit, when there is a long delay after transmitting an order from the POS until the payment is completed, the serial number may be duplicated with that of the next POS.

For example, when the serial number is ‘7’, a lot of time is delayed due to the customer's inexperience in using the smartphone, and the like, and the payment is made quickly at the next POS, the serial number 7 may be generated again starting from number 8.

To prevent this, it is checked whether the serial number to be issued is a serial number currently waiting for payment. When the serial number is a serial number waiting for payment, the next number may be used.

Alternatively, when a two-digit serial number is used, such a case may be prevented.

After serial number 7 is generated, it proceeds to number 99, and it takes a lot of time until it becomes number 7 again, so that there is no case where the serial number is duplicated due to failure to pay during that time.

Of course, in a large store such as a department store, when plural POSs use a single QR code, more than 3 digits may be used.

An integrated order number for each store QR code may be generated, and the last 2 or 3 digits of the integrated order number may be used as a serial number.

In addition, the serial number may be used as a waiting number waiting for food to be served after ordering at a food court, highway rest area, or coffee shop.

In step 2-3, the integration server returns the integrated order number and serial number after saving the QR code, payment amount, integrated order number and serial number.

In step 2-4, the POS integration module receives the integrated order number and serial number, and displays the serial number on the POS screen.

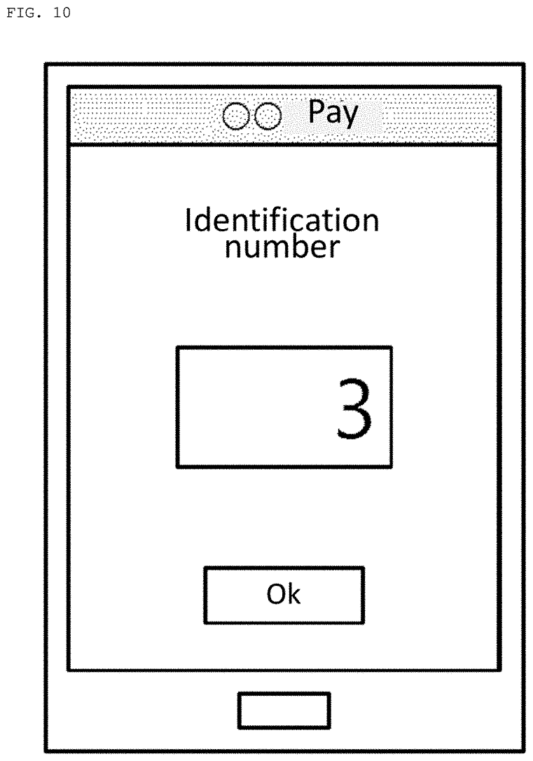

In step 3, the store employee guides the customer to the serial number, the customer runs the payment app, scans the store QR code, and then inputs the serial number on the screen as shown in FIG. 10.

Of course, when a customer monitor is attached to the POS or there is a device such as a waiting number display device, the serial number may be shown thereon.

In step 4, the payment app transmits the store QR code and serial number to the server, and receives the order information.

In step 4-1, the linking module transmits the store QR code and serial number to the integration server.

In step 4-2, the integration server includes the transmitted store QR code and serial number, and searches for an order in the payment waiting state.

In step 4-3, the integration server returns the integrated order number and payment amount of the corresponding order.

Third, the QR codes may be assigned to each POS as follows.

For the present invention, the QR code may be configured to recognize the POS as in the following example.

00000001-0001-02

Where the first number or code separated by “-” is information for identifying the store.

Of course, in the case of operating a server for each store, store identification information is not required.

The second number or code is information identifying each store in the case of a store that has plural stores, such as a franchise.

When a plurality of stores exists, such as a department store or an outlet, each store may mean each shop.

The third number or code is information identifying the POS in the store.

Since there may be plural POSs in one store, a number or code is assigned to each POS.

Of course, a store using a single POS may omit the shop identification information or POS identification information, or replace it with a specific number or code such as “0000”.

Each store receives a QR code as follows after subscribing to the integration server.

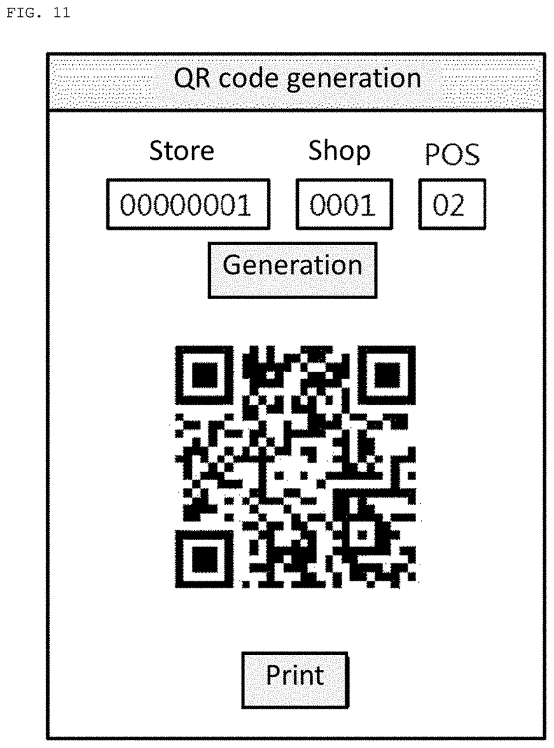

Each store or shop manager may log in to the integration server, directly input and print store identification information and POS identification information on the screen as shown in FIG. 11.

Although the integration server is required to manage store information to settle fees with each store or to impose service fees, but as described below, each store and POS identification information is only information for searching for orders, so that there is no need to manage store and POS identification information separately.

Of course, in order to show the shop name or POS device number as well as the store name, the integration server may manage information about the shop or POS as described below.

Hereinafter, the payment process according to the present invention will be described in detail with reference to the drawings.

In step 1, the store associate inputs the order into the POS and clicks the confirm button.

In step 2, the POS transmits the QR code and order details to the integration server, and receives the integrated order number.

In step 2-1, the POS transmits its QR code and order information including a payment amount to the integration server.

In step 2-2, the integration server generates an integrated order number that can identify the corresponding order.

In step 2-3, the integration server saves the integrated order number, QR code, and order information.

In this case, the order state is saved as the payment waiting state.

In step 2-4, the integration server returns the integrated order number.

In step 3, the customer runs the payment app and scans the QR code of each POS.

In step 4, the payment app transmits the QR code to the server and receives the order information.

In step 4-1, the payment app transmits the QR code to the integration server.

In step 4-2, the integration server searches for an order that is waiting for payment while including the transmitted QR code.

In step 4-3, the integration server returns the order information including the integrated order number and payment amount of the corresponding order.

In step 5, the payment app pays with the QR code and payment amount, and transmits the payment result and integrated order number to the integration server.

In step 6, the integration server searches for an order based on the integrated order number and saves the payment result.

Thereafter, the POS receives the payment result in the same manner as above, and saves the order.

Fourth, when it is difficult to assign and print a QR code as in the third method, the customer may scan the QR code and input the POS number after printing the POS number and attaching it to the POS.

In step 1, the store employee inputs the order into the POS and clicks the confirm button.

In step 2, the POS transmits the QR code, POS number, and order details to the integration server, and receives the integrated order number.

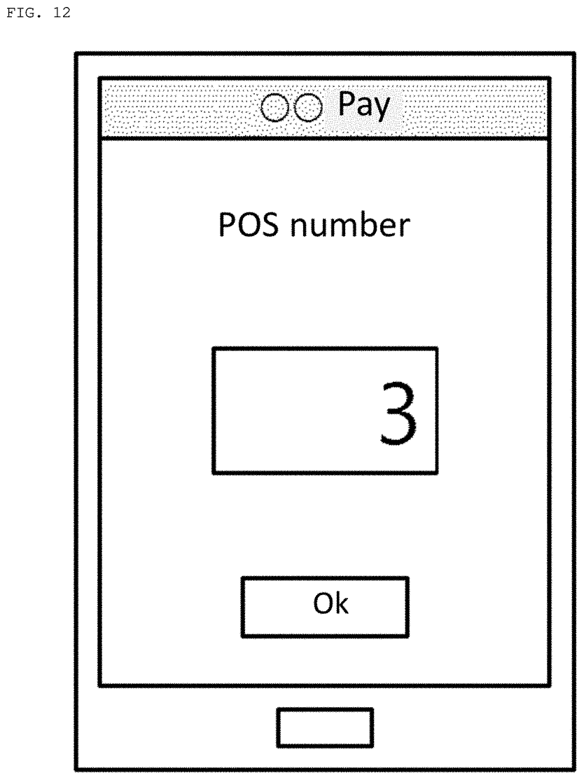

In step 3, the customer runs the payment app, scans the QR code of each POS, and then inputs the POS number on the screen as shown in FIG. 12.

In step 4, the payment app transmits the QR code and POS number to the server, and receives the order information.

In step 4-1, the payment app transmits the QR code and POS number to the integration server.

In step 4-2, the integration server searches for an order that is waiting for payment while including the transmitted QR code and POS number.

In step 4-3, the integration server returns the order information including the integrated order number and payment amount of the corresponding order.

In step 5, the payment app pays with the QR code and payment amount, and transmits the payment result and integrated order number to the integration server.

In step 6, the integration server searches for an order based on the integrated order number and saves the payment result.

Thereafter, the POS receives the payment result in the same manner as above, and saves the order.

According to the present invention, it is convenient because it is not only possible to pay with QR pay at online shopping malls and a user does not required to input the payment amount. In addition, it is very convenient because there is no need to visually check every payment result in offline stores, and all management can be done at the POS.

In order to implement the present invention, it is necessary to change the POS program to link with the server. When it is difficult to change the POS program immediately, a separate program may be used.

The store employee may install and use the app in a PC or smartphone.

It may also be used in stores that do not have POS devices.

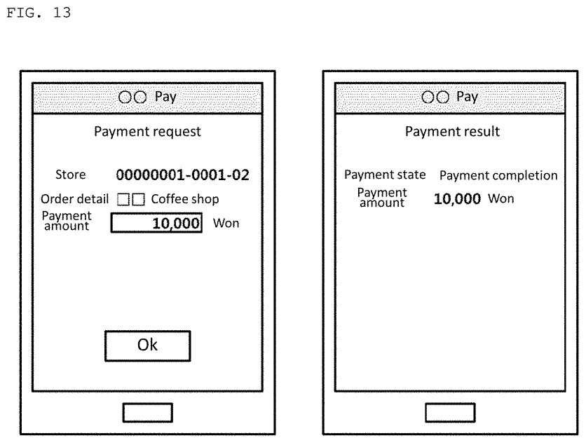

In step 1, when the store employee executes a separate app, a screen as shown in the first of FIG. 13 appears.

In this case, the QR code may use preset information, and since it is difficult to input order details one by one, fixed information may be used.

In step 2, the store employee checks the payment amount of the POS, inputs it into a separate app and clicks the confirmation button, as described above, the separate app transmits the QR code and order information, and receives the order number.

In step 3, when the customer clicks the button after making payment, the separate app transmits the received order number to the server, receives the result, and displays it on the screen as shown in the second screen of FIG. 13.

Although the store employee has to enter the payment amount, and the payment result is not saved directly in the POS, at least there is no need to inform the customer of the payment amount. In addition, there is no need for the customer to input the payment amount, and it is possible to prevent the customer from inputting the wrong amount intentionally or by mistake. Further, there is no need to visually check whether the payment is abnormal and the payment amount.

Currently, various QR pay services are used, and each payment service must issue and print a QR code for each store or shop, and provide a QR code kit, so that this requires a lot of money and effort. In addition, because stores also have to have QR code kits for all payment services they subscribe to, so that the management is difficult and complicated.

In the case of transmitting the store QR code as described above, because the QR code provided in the store is not scanned, a QR code is issued for each store or shop, and the same QR code kit is provided to all stores without the need to print.

However, in the case of scanning the QR code provided in the store above, each payment service must issue a QR code for each store or store, print and provide a QR code kit. Because the QR code must be discarded and a new QR code must be issued and kept in order to provide a QR code kit for each POS, it takes a lot of cost and effort.

Therefore, when the QR integrated service is used as follows, the QR code kit may be commonly used regardless of the payment service.

To this end, each store registers the QR Pay service registered as a merchant in advance and the merchant code of the corresponding service to the integration server as follows.

hknets, ZeroPay, 1-ZP-201811900011-M201811900000011-Zmlg

hknets, KakaoPay, https://qr.kakaopay.com/281006012000000000529148

hknets, integration QR, 00000001-0001-01

hknets, integration QR, 00000001-0001-02

hknets, integration QR, 00000001-0001-03

Of course, when different QR codes are assigned to each store even in the same store in the QR Pay service, the QR codes may be saved for each store.

hknets, extra points, ZeroPay, 1-ZP-201811900011-M201811900000011-Zmlg

hknets, extra points, KakaoPay, https://qr.kakaopay.com/281006012000000000529148

hknets, extra points, integration QR, 00000001-0001-01

hknets, extra points, integration QR, 00000001-0001-02

hknets, extra points, integration QR, 00000001-0001-03

When the customer runs the payment app and any OR codes are scanned, it is possible to obtain the store's QR code as follows.

For example, the payment app transmits the following information to the integration server.

https://qrpays.com/pay.jsp?qid-ZeroPay&qr-00000001-0001-02

Where ‘qid’ is the payment app's own QR code payment service, which it means ZeroPay in this case, and ‘qr’ is the QR code scanned by the customer.

In this case, as described above, it is a separate QR code assigned to each POS.

The integration server obtains the store QR code by searching for the store information based on the QR code as follows.

In step 1, the integration server searches for the store using the transmitted QR code.

The integration server checks whether the store is a merchant of the payment service. When the store is a merchant, the next step is performed. If not, an error message is returned.

In the present example, the store having an ID of ‘hknets’ is searched.

In step 2, the transmitted QR code service among the QR codes used by the store is searched.

When the QR code payment service is registered, the next step is performed, otherwise, an error message is returned.

In the present example, the ZeroPay service is searched among the QR code payment services of the store having the ID of ‘hknets’, and the QR code of ‘1-ZP-201811900011-M201811000000001-Zmlg’ may be obtained.

The integration server returns the store QR code of the corresponding service as follows.

qr:1-ZP-201811900011-M201811900000011-Zmlg

When the payment service identification information is not transmitted as above, a list of available payment services and store QR codes is returned as shown below, and the user may select them.

ZeroPay, 1-ZP-201811900011-M201811900000011-Zmlg

KakaoPay, https://qr.kakaopay.com/281006012000000000529148

In addition, order information may be returned by searching for an order from the transmitted QR code as in the above example.

qr:1-ZP-201811900011-M201811900000011-Zmlg

ordid:20190115000100

amount:10000

When processed as above, each store only needs to have one QR code kit, and for the remaining QR Pay services, there is no need to print a QR code for each store or shop.

In addition, when the QR code given to each POS by the integration server is used, all QR Pay services do not need to print the QR code for each store or shop, and it is possible to easily identify the order for each POS.

It is possible to perform the above scheme while linking with an order as follows.

First, the customer may run the payment app and scan and process any QR code.

In step 1, the customer runs the payment app and scans any QR code.

In step 2, the payment app transmits its identification information and QR code to the integration server as described above, and receives information about the store QR code and payment amount of the payment service from the integration server, which is required for payment.

In step 3, the payment app pays based on the store QR code and payment amount.

In step 4, the payment app transmits the payment result to the integration server.

In step 5, the integration server searches for an order based on the integrated order number and saves the payment result.

Then, the POS receives the payment result and saves the order.

Second, instead of the payment app transmitting its own service identification information, the integration app may transmit the identification information and the QR code of the payment service selected by the user as described above, and receives order information.

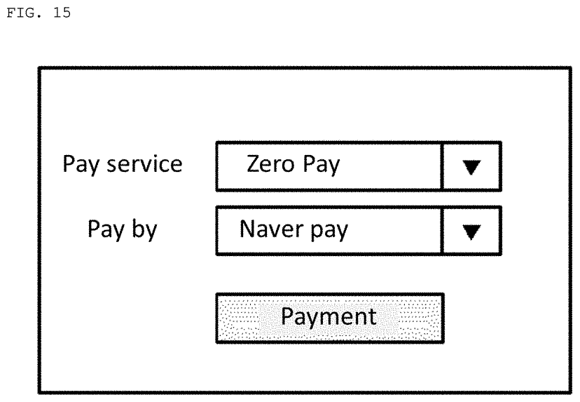

In step 1, the customer runs the integration app, selects a payment service and a payment app on the screen as shown in FIG. 15, and scans any QR code.

When there are several apps used in the payment service such as ZeroPay and a payment service is selected as shown in FIG. 15, apps available in the corresponding payment service are searched and displayed in a payment app selection window.

When there is only one app used in the payment service, such as Kakao Pay, the payment app selection process may be omitted.

In step 2, the integration app transmits the identification information and QR code of the payment service selected by the customer to the integration server, and receives information required for payment from the integration server.

In step 3, the integration app transmits the received information to the payment app selected by the customer.

The POS then receives the payment result and saves the order.

Third, the integration app transmits the QR code to the integration server, and downloads payment services available at the corresponding store, which can be selected by the user.

Step 1, the customer runs the integration app and scans the QR code.

In step 2, the integration app transmits the QR code to the integration server as in the above example, and receives information required for payment from the integration server.

In this case, the identification information of the payment service registered by the corresponding store as a merchant and the store QR code are downloaded together.

In step 3, the integration app shows payment services and payment apps available in the store as shown in FIG. 15, and the customer selects a payment service and a payment app.

In step 4, the integration app delivers information such as the QR code and payment amount of the payment service selected by the customer to the payment app.

Thereafter, the POS receives the payment result and saves the order.

In this case, because each store can use all the QR Pay services they have subscribed to when they have only one QR code kit, it makes it easier to manage QR code kits. In addition, for each QR Pay service, the POS link function described above can be applied without having to re-create a QR code kit for each POS or modify the functions of the server, so convenience is greatly improved and costs are reduced.

In addition, when the store QR code provided by the QR Pay service is scanned, each store must register as a merchant in each QR Pay service and receive a QR code to distinguish the stores. However, when not the store QR code but the integrated QR code provided by the integrated service is scanned, the entire store may use one QR code for each payment service.

That is, the integrated service company may subscribe to each QR pay service and receives a QR code, and all stores may use the QR code of the integrated service company.

In this case, the QR pay service may not distinguish the stores, but the integrated service may distinguish the stores by the member ID and use the integrated order number to distinguish each order.

Therefore, like a credit card company's flagship merchant, an integrated service provider may register as a merchant in each QR Pay service and provide services to plural stores.

To this end, it is processed as follows.

First, the integrated service provider subscribes to each QR Pay service as a merchant and receives a QR code.

In the case of payment by scanning the QR code provided in the store, the integrated service provider provides a kit on which its own integrated QR code is printed instead of the QR code of the QR Pay service.

An integrated service provider may produce and transmit a QR kit, and the integrated service may provide a QR code printing function. Each store may print the QR code on the screen as shown in FIG. 11.

Thereafter, services are provided to a plurality of stores in the same manner as above.

That is, the remaining processes are the same, and the store QR code is transmitted as follows.

When the store QR code is transmitted from the integration module to the payment module selected by the customer, the store QR code of the integrated service provider of the payment service selected by the customer is transmitted.

That is, when ZeroPay is selected on the screen as shown in FIG. 15, the QR code of the ZeroPay store of the integrated service is transmitted.

When the payment app scans the store QR code, it returns the store QR code of the payment service corresponding to the identification information transmitted by the payment app.

That is, when the payment app transmits the identification information of ZeroPay as in the above example, it returns the ZeroPay shop QR code of the integrated service.

Because all stores use the same store QR code for each QR Pay service, payment is made for one store in the payment service.

However, in the integration server, since the member ID of each store is saved in each payment case, the store may be distinguished for each payment case.

Thereafter, the integrated service provider settles in mutually negotiated scheme with each store.

Because payment is made based on the QR code of the integrated service provider, each QR Pay service settles with the integrated service provider regardless of the actual store.

The integrated service provider saves settlement information for each order when settling with each QR Pay service.

Thereafter, when settling with each store, the settlement is performed with each store based on the store ID saved in each order.

In addition, in the case of cancellation processing or settlement with the QR Pay service at each store above, because each store needs to know the QR Pay service transaction number for cancellation processing or settlement, as in the example above, the transaction number of the QR Pay service must be transmitted to the shopping mall or POS. However, when the integrated service provider becomes the representative merchant and also handles cancellation processing and settlement, because each store may distinguish each payment based on the integrated order number of the integrated service instead of the transaction number of the QR Pay service, instead of the transaction number of the QR Pay service, the integrated order number of the integrated service may be transmitted to each shopping mall or POS.

According to the present invention, it is possible to reduce the cost of issuing a QR kit because there is no need to issue a QR code for each store or shop even in the QR pay service.

In the above, instead of linking with the payment app, after the customer pays with an existing payment app, the linking system accesses to the QR pay server as follows, searches for a payment case that matches the customer's payment history, and returns the result. Then, the shopping mall or POS receives and saves the result, so that it is possible to verify customer payments and to link with shopping malls or POS.

In addition, when a cancellation process is requested from a shopping mall or POS, the linking system may access to the QR Pay server in the same manner to process cancellation.

To do this, it is required to check the following points:

First, in the QR Pay payment method, because the customer inputs the amount at will, it is necessary to check whether the amount paid by the customer is correct.

Second, it is required to know the transaction number to process refunds, and the like, but because it is impossible to receive the transaction number, it is required to check the transaction number.

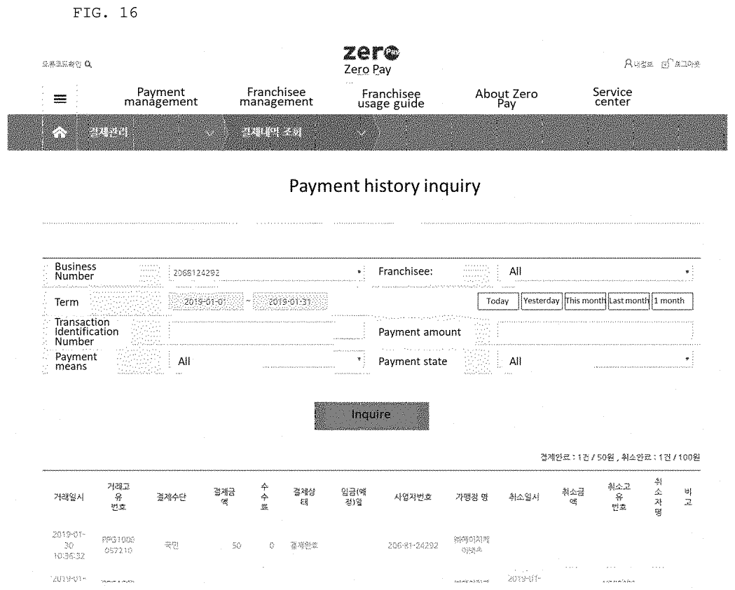

As shown in FIG. 16, when login to the ZeroPay server is performed, it is possible to check the payment time, transaction number, payment amount, payment means, and the like for each payment case.

Therefore, it is possible to check by automatically logging in to the ZeroPay server by linking with the ZeroPay server or using technologies such as scraping or web learning (a technology that can freely run a web browser).

Of course, since the ZeroPay server uses an encryption module, it is technically difficult to connect by scraping, but for convenience of explanation, the scraping scheme will be described as an example.

First, a case where the present invention is applied to an online shopping mall will be described.

In the description below, the linking module or integration module refers to a module that connects to the QR Pay server to search for and compare payments.

Since ZeroPay is a method in which a customer photographs a ZeroPay QR code with his smartphone, shopping malls first submit the ZeroPay QR code images to the integrated service.

It is mainly used on a PC because it is not possible to scan the ZeroPay QR code displayed on the smartphone screen with a smartphone.

The method of searching for a product in the shopping mall and moving to the payment screen is the same as that of the related art, so it will be omitted from the present description, and a process of selecting and paying for the ZeroPay payment that a customer uses on the payment screen will be described.

In step 1, the shopping mall server transmits information about an order number and the amount to be paid by the customer to the integrated service.

https://qrpays.com/pay.asp?id-hknets&amount-10000&ordid-123456& returl-https://www.xxxmall.com/pay/return.asp

Where ‘mid’ is the integrated service member ID of the shopping mall, ‘amount’ is the amount to be paid, ‘ordid’ is the order number of the shopping mall, and ‘returl’ is the URL of the shopping mall through which the payment result is to be returned.

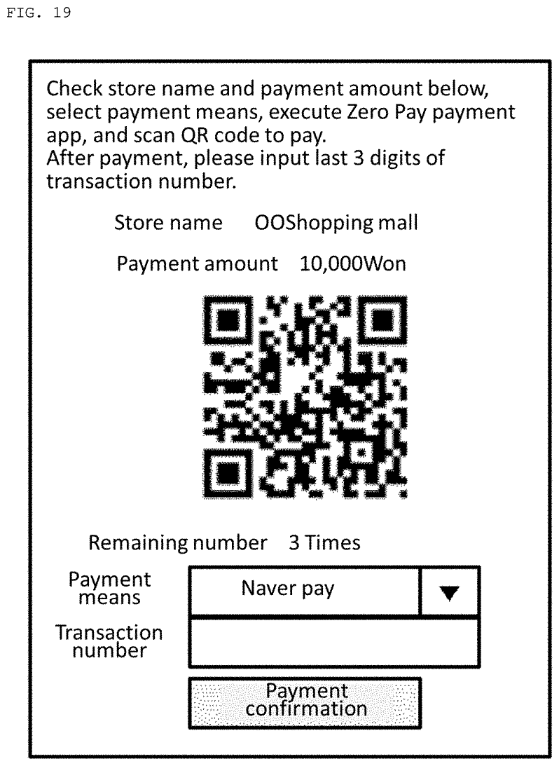

In step 2, the integration module shows the ZeroPay QR code on the screen as shown in FIG. 19.

The store name is the name of the shopping mall searched for based on ‘mid’, and the payment amount is the amount received from the shopping mall.

Because ZeroPay may allow several QR codes to be issued to one operator in order to distinguish franchise stores, when different QR codes are shown from time to time after receiving as many QR codes as possible in a shopping mall, it is possible to minimize the cases of two or more searches.

For example, when three QR codes are issued, it is possible to show different QR codes according to the current time as follows.

Select Case Second(Now) Mod 3

Case 0: Display the first QR code

Case 1: Display the second QR code

Case 2: Display the third QR code

End Select

Alternatively, in ZeroPay, QR code bands may be provided to each store as follows, and the integration module may show QR code images so that they do not overlap.

1-ZP-201811900011-M201811900000011-Zmlg-XXXXXX

That is, when a 6-digit band is provided as above, it starts from ‘000000’ and increases to ‘999999’, and then changes to 000000 again after 999999, there may be no duplicates unless the payments are made with ZeroPay for 1,000,000 orders during the search as follows.

In step 3, the customer runs the ZeroPay payment app on the smartphone in the same manner as the existing ZeroPay payment, the QR code on the screen is scanned as shown in FIG. 19, and the payment is made after inputting the amount.

Information about a transaction number, payment means, a payment amount, and payment time is saved in the ZeroPay server.

In step 4, the customer inputs the following on the screen as shown in FIG. 19 after the ZeroPay payment, and clicks the payment confirmation button.

First, the transaction number is input.

Although the search is performed without inputting a transaction number, in the case of a shopping mall, it is difficult to accurately search without a transaction number because plural customers make payments at the same time.

When the entire transaction number is input, no other information is required.

Since it is inconvenient to input the entire transaction number, as in the example of FIG. 19, it is possible to specify and input a part such as the last three digits.

Second, transaction means is selected.

When a transaction number is not input or only a part thereof is input, transaction means may be selected to increase the accuracy of search.

In addition, in order to prevent maliciously not paying or paying an amount less than the amount to be paid, and retrying while changing the payment means or transaction number until the transaction is found, the number of retries is limited as shown in FIG. 19. In the case of not finding a matching case in step 5, the number of retries is subtracted, and step 4 is performed again, the process may be terminated when the remaining number of cases is 0 (zero).

In step 5, the integrated service uses the integration module to check customer payment details.

In step 5-1, the integration module logs in to the ZeroPay affiliated store management homepage with the ZeroPay affiliated store ID and password of the integrated service.

Each shopping mall or store may register an ID and password in the integration server in advance.

Alternatively, in the case of a store POS, a login window may be shown to the store employee at each POS when the linking system is activated, thereby enabling the store employee to log in.

It is checked whether the log-in is performed normally by analyzing the returned content after logging in as follows.

strResponse=OpenURL_Post (“https://www.ZeroPay.or.kr/loginProcess.do”, “id=hknets&password=1234”)

Of course, when the log-in is already completed, step 5-1 is skipped and the next step is performed.

In step 5-2, the integration module calls the ZeroPay server as follows.

pageIndex=1&recordCountPerPage=10&firstIndex=1&lastIndex=10&fin dFromDt=20190101&findToDt=20190131&bmanRegiNum=&afstrId=&findAfstrId=201901039623&findSetlTranChrcNo=PPG1000+057210&findTranAmt=10000&findSetlMeanCode=PNV&findTranStatCode=00&_csrf=0b334802-37fd-4a29-ba6b-934cafa11a41&findBmanRegiNum=2068124292

First, a merchant code (findAfstrId) is transmitted.

Because the merchant code is a part of the ZeroPay QR code, the merchant code may be obtained from the QR code.

Second, when the customer inputs the entire transaction number, the transaction number (findSetlTranChrcNo) is transmitted.

Third, the payment amount (findTranAmt) is transmitted.

Fourth, when the customer selects payment means, the payment means is transmitted.

Fifth, the payment state (findTranStatCode) is transmitted.

Sixth, the search period (findFromDt, findToDt) is transmitted.

When a time other than a date can be specified in the period, the time is transmitted.

Because the inquiry is performed in almost real time, payment cases are detected for a short period of time, such as within 5 minutes from the current time, or payments made after the time when the screen of FIG. 19 is displayed above are detected.

When only the date can be specified as in ZeroPay, the start and end dates may be selected as today, and when it is slightly past midnight, such as 0:01, the start date may be specified as yesterday.

In step 5-3, the integration module compares the search results as follows.

In this case, ‘nPrice’ is the amount of payment transmitted above, ‘nCount’ is the number of searched cases, ‘sACID1’ is the transaction number of each searched payment, ‘nPrice1’ is the payment amount of each searched payment, and ‘nTime1’ is defined as the transaction time of the searched payment. It is implemented as follows.

nTime=DateAdd(“s”, −300, Now)

For i=1 To nCount

nPrice1= . . . .

sACID1= . . . .

nTime1= . . . .

If nPrice1=nPrice Then

If nTime1>=nTire Then

If Mid(sACID1, Len(sACID1)−2, 2)=sACID Then

sNewACIDs=sNewACIDs & “,” & sACID1‘′’ Transaction number addition

End If

End If

End If

Next

In step 5-3-1, the QR codes are compared.

As described above, it is possible to search based on the affiliated store code (findAfstrId), but in the case where the band is provided in the above, the search may be performed only by the QR code excluding the band.

Therefore, the QR codes are compared to check whether they match.

In step 5-3-2, whether the amounts match is checked by comparing them.

Of course, in step 5-2, it is omitted in the case of searching including the amount.

In step 5-3-3, when a transaction number is input, the transaction number is compared.

Of course, when the customer inputs the entire transaction number and search including the transaction number in step 5-2 is performed, it is omitted.

When only a part of the transaction number is input, comparison is performed to check whether a part of the transaction number is the same as above.

In step 5-3-4, payment time is compared.

When the search is performed including the transaction time in step 5-2, it is omitted.

The payment made within a short period of time is detected based on the same criteria as in step 5-2.

In step 5-4, the integration module transmits a list of transaction numbers (sNewACIDs) that meet the above conditions to the integration server. The integration server compares each transaction number with the data saved in the database to determine whether it is a new transaction number, and returns the new transaction number.

rs.Open(“SELECT ACID FROM . . . ”)

Do While Not rs.EOF

If rs(“ACID”)=sACID1 Then

[Exclusion]

Else

sNewACIDs=sNewACIDs & “,” & sACID1

End If

rs.MoveNext

Loop

In step 5-5, finally, according to the number of transactions that meet the conditions, it is processed as follows.

First, when there is no payment that meets the conditions, an error is returned.

Second, when there is only one transaction that meets the conditions, because it can be regarded as a payment by the customer, the transaction number of the case is transmitted to the next step.

When a customer inputs an incorrect amount, another customer's payment with the same amount may be recognized as the customer's payment, but in that case, another customer's payment will not be recognized as a new transaction, and contact is immediately made from another customer so that it is possible to check it immediately.

Third, when two or more transactions that meet the conditions are found, it may be recognized that two or more customers paid at about the same time.

Although it is not necessary to identify which customer's payment was made, when the customer later cancels the order and refunds, it is required to know what a refund is in order to process the refund.

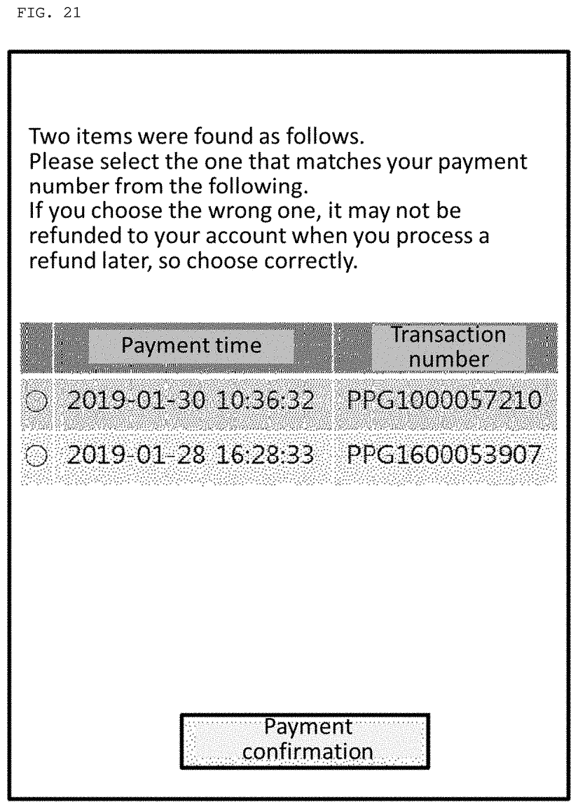

Therefore, the linking module shows the transaction number of the corresponding payment case to the customer as shown in FIG. 21 and confirms it, and then transmits the transaction number selected by the customer to the next step.

In step 5-6, in case of a normal payment, the integration module transmits the transaction number to the integration server, and the integration server saves the transaction number in the database and compares it when searching next time.

In step 6, the integrated service transmits the payment confirmation result, identification number, and shopping mall order number to the shopping mall.

https://www.xxxmall.com/pay/return.asp?retcd=OK&acid=PPG1900115 116& ordid=123456

In step 7, the shopping mall saves the order details and transaction number.

Of course, when there is no match in the payment amount or an error is returned because a new transaction number cannot be found, an error message is shown to the customer, and after confirming or canceling through a call with the customer, payment is made again.

In offline stores, after inputting an order in the POS, when the customer pays with ZeroPay, the linking system is called and search is performed as above.

In stores, of course, customers scan the QR code provided in the store.

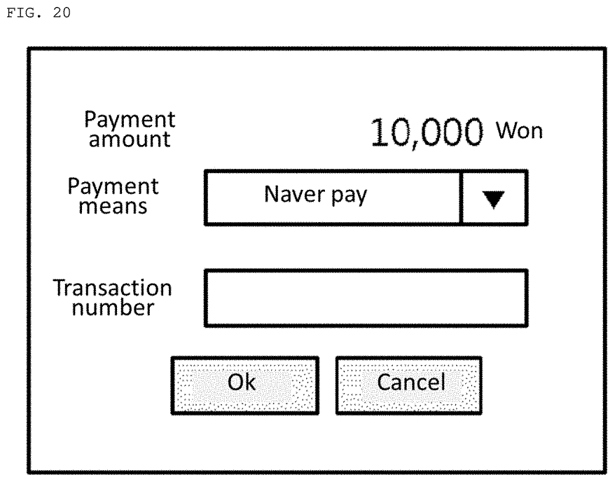

The linking system shows a screen as shown in FIG. 20, and the store employee selects payment means and inputs a transaction number.

In addition, when two or more cases are found, the linking module displays a screen on the POS as shown in FIG. 21, and the store employee perform the selection by looking at the customer's smartphone screen or the ZeroPay store app.

Unlike online shopping malls, offline stores do not need to input a transaction number because the next order is processed after payment for one order is completed.

However, when several POSs use one QR code, the number of selections from several transaction numbers may be reduced by inputting the transaction number.

Thereafter, when the customer cancels, it will be processed as follows.

In step 1, after searching for the order in the POS and the cancel button is clicked.

In step 2, it is transmitted as follows.

https://qrpays.com/pay/cancel.asp?id-hknets&acid-PPG1900115116

In step 3, the ZeroPay linking system processes it as follows.

In step 3-1, first, by checking the ID and password, it is determined whether the user is a normal user.

In step 3-2, log-in to the ZeroPay server with the ZeroPay affiliate ID and password is performed.

In step 3-3, a payment case is detected based on the transaction number (acid).

When there is a detected case, the next step is performed, otherwise an error is returned.

In step 3-4, the system cancels to the ZeroPay server and returns that it has been processed normally.

In step 4, when an order is processed normally, the POS will cancel the corresponding order.

According to the present invention, it is convenient because it is not only possible to pay with QR pay at online shopping malls and the store does not required to input the payment amount. In addition, it is very convenient because there is no need to visually check every payment result in offline stores, and all management can be done at the POS.

As follows, the payment app displays the payment result as a barcode or QR code on the smartphone screen, and it is possible to confirm it by scanning the barcode or QR code with a barcode or QR code scanner at the store.

In step 1, when a customer makes an order, the store inputs the order details into the POS.

In step 2, the customer runs the ZeroPay app in the same scheme as in the related art, the store QR code is scanned, and the payment amount is input and pays.

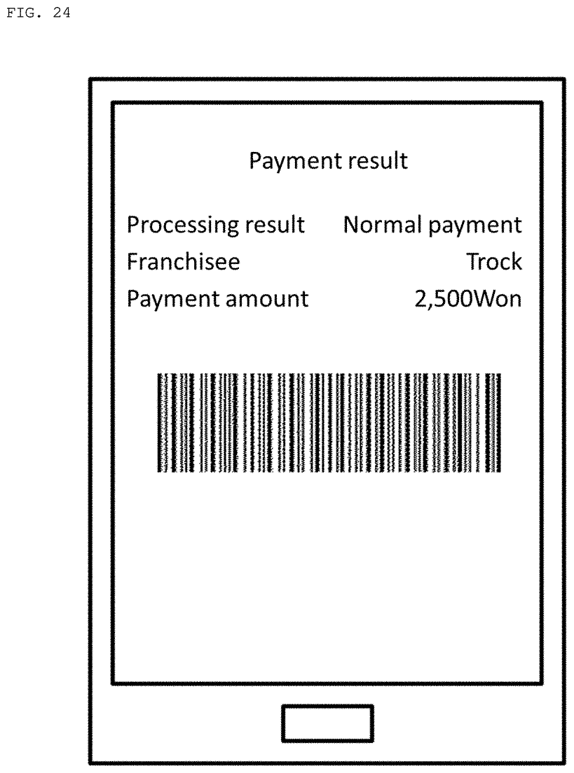

In step 3, the ZeroPay payment app shows information about the payment time, payment amount, and transaction number on the screen in the form of a barcode or QR code as shown in FIG. 24 after payment.

In step 4, when the customer presents the smartphone screen, the store scans the barcode or QR code on the smartphone screen with a scanner connected to the POS.

In step 5, the POS compares the scanned information as follows.

In step 5-1, the payment amount and the amount input into the POS are compared to determine whether they match.

In step 5-2, because there is a possibility that the screen on which the customer has previously paid is displayed, it is checked whether the payment is recent within 1 minute from the current time.

In the normal case, it proceeds to step 6, and in the abnormal case where the amount does not match, an error message is displayed.

In step 6, the POS saves the order details and transaction number.

As described above, the payment result may be displayed as a QR code.

Because a lot of information can be displayed through a QR code, the QR code may include all information such as payment time, payment amount, transaction number, and the like.

However, the downside is that few stores have QR code scanners.

Because it is not difficult to add a QR code scanning function to a smartphone app, when a store app is provided, such as ZeroPay, the function is added to the store app.

In particular, because the store app has a function of receiving payment information from the ZeroPay server, it is easy to implement the above function.

However, a separate method is required to link with POS.

Payment results may also be displayed as barcodes.

In the case of barcodes, because there is a limit to the information that can be displayed, in this case, it is processed as follows.

First, only the payment time and payment amount are displayed and compared.

Even in this case, in order to prevent the barcodes from becoming dense to reduce the recognition rate, the amount is expressed in exponential form or in hexadecimal or 62 digits instead of decimal to reduce the number of digits, and converts it back to numbers in step 4 or 5 for processing.

Second, the transaction number is displayed, and in the same method as above, the linking system may log in to the ZeroPay server for search, and then, returns and compares the payment amount and the payment time.

According to the present invention, although it is inconvenient that the customer has to input the payment amount directly, the POS automatically checks the payment amount and obtains the transaction number, so it is convenient because there is no need to visually check the payment amount at the store or check the payment amount or payment number on the ZeroPay server.

In the present invention, ZeroPay has been described as an example, but it can be applied to various payment means for payment by scanning QR codes.

In addition, the above is only one embodiment of the present invention, and various modulations and modifications are possible within the scope of the present invention.

### INDUSTRIAL APPLICABILITY

Free Text

1. A method and a system for linking QR pay, wherein, instead of running a payment application, scanning a store QR code, and inputting a payment amount by a user, the linking system transmits the store QR code and the payment amount to a payment module, and the payment module processes payment based on the received store QR code and payment amount, and transmits a result of the payment to the linking system.

2. The method and system of claim 1, wherein the system includes:
a store interworking module that interwork shopping mall or POS
a payment app interworking module that interwork payment app
Interworking server for saving and retrieving payment information

3. The method and system of claim 1, wherein the method includes:
transmitting the store QR code, the payment amount and an order number to the payment module;
performing, by the payment module, payment based on the received store QR code and payment amount; and
transmitting, by the payment module, a payment result to the linking server.

4. The method and system of claim 1, wherein the method includes:
transmitting the store QR code and payment amount to the payment module by the linking module when a customer selects QR payment in an Internet shopping mall;
performing, by the payment module, a payment based on the received store QR code and payment amount;
transmitting or returning, by the payment module, a transaction number to the linking server after payment; and
transmitting, by the linking module or the linking server, a payment result to a shopping mall server.

5. The method and system of claim 1, wherein the method includes:
displaying, by the linking module, information required for payment as a QR code on a screen when a customer selects QR payment in an Internet shopping mall or offline store;
executing, by the customer, a smartphone payment app and scanning the QR code;
receiving, by the smartphone payment app, the information required for payment;
performing, by a payment app, payment based on the received store QR code and payment amount;
transmitting or returning, by the payment app, a transaction number to the linking server after payment; and
transmitting or returning, by the linking module or the linking server, a payment result to a store server.

6. The method and system of claim 5, wherein instead of a QR code, a PC or POS linking module transmits the information required for payment to the smartphone payment app in various schemes including
a scheme of transmitting an URL to a customer's mobile phone and touching the URL by a customer,
a scheme of transmitting information to an NFC device, and receiving information as the customer approaches a smartphone to an NFC device, and
a scheme of informing the customer of an order number, and inputting the order number into the linking module or the payment module by the customer.

7. The method and system of claim 5, wherein the linking module receives the information required for payment instead of the payment app and transmits the information to the payment app.

8. A method and a system for linking QR pay, wherein a linking server saves order information when a POS transmits the order information, the linking server searches for an order based on a store QR code and returns information required for payment when a customer scans the store QR code, and
a payment module pays based on the received store QR code and a payment amount, and transmits a payment result to the linking system.

9. The method and system of claim 8, wherein the method includes:
saving, by the linking server, the order information in a payment waiting state and returning the order number when the POS transmits the order information to the linking server,
transmitting, by the linking module, the store QR code to the linking server when the customer executes a linking app or a payment app and scans the store QR code, and returning, by the linking server, the information required for payment including the order number and the payment amount after searching for recent order in a payment waiting state among orders including the transmitted QR code or orders of a store using the transmitted QR code;
paying based on the received payment amount by the payment app;
searching for an order based on the order number, saving a payment result, and changing an order state to a payment completion state by the linking server when the payment app transmits the order number and the payment result to the linking server; and
searching for an order based on the order number and returning the payment result by the linking server when the POS transmits the order number to the linking server.

10. The method and system of claim 8, wherein an order list is displayed to the customer to allow the customer to select an order when there are a plurality of orders in a payment waiting state.

11. The method and system of claim 8, wherein a QR code is assigned to each store POS to classify orders based on the QR code.

12. The method and system of claim 8, wherein a number is assigned to each store POS to classify orders, and the customer inputs the number after scanning the QR code;

13. The method and system of claim 1, wherein a separate app is provided when there is no linkage to the POS, the store inputs the payment amount to the separate app and pays in a manner as above, and the separate app receives a payment result.

14. The QR code integrated service of claim 1, wherein after the store registers an QR pay service subscribed and a store QR code of the corresponding service to an integrated service,
when a customer executes an integration app or payment app and scans anything of store QR codes, the linking module transmits QR pay service identification information and the QR code to an integration server
the integration server searches for based on service identification information and the QR code return the store QR code of the corresponding service of the store.

15. The QR code integrated service of claim 14, wherein the QR code integrated service includes:
registering, by the store, the QR pay service to which the store subscribes and the store QR code of the corresponding service to the integrated service;
when the customer executes the payment app and scans any QR code in a store, transmitting, by the payment app, the service identification information of the payment app and the QR code to the integration server;
searching for the store based on the QR code by the integration server;
searching for the QR pay service registered by the store based on the service identification information by the integration server; and
returning the store QR code of the corresponding service of the store by the integration server.

16. The QR code integrated service of claim 1, wherein an integrated service company subscribes to the QR pay service, and
the integrated service process payment by transmitting the store QR code assigned by each QR pay service to the payment module, and settles with each QR pay service, and each store.

17. The QR code integrated service of claim 16, wherein the QR code integrated service includes:
providing, by the integrated service, each store with an integrated QR code for identifying a store, a shop or a POS;
scanning, by the customer, the integrated QR code provided by the integrated service; and
recognizing, by the integrated service, the store based on the integrated QR code;

18. The QR code integrated service of claim 17, wherein, when transmitting a payment result to a shopping mall or POS, an order number of the integrated service is transmitted instead of a transaction number.

19. A method and a system for linking QR pay, wherein, after a customer pays with QR pay at a shopping mall or offline store, check payment amount and get a transaction number by automatically accessing a QR pay server and searching for a payment that matches customer's payment details, and
interwork with the shopping mall or store POS.

20. The method and system of claim 19, wherein the method includes all or part of:
By adding data transmitted from the shopping mall or POS to a QR pay server search condition or comparison after search;
searching for a recent payment such as within 5 minutes from current time;
searching for a payment that matches an amount to be paid by the customer;
searching for a payment that matches the transmitted QR code; and
searching for a payment that matches some or all of a transmitted transaction number.

21. The method and system of claim 19, wherein the transaction number of the retrieved payment is compared with a transaction number stored in the linking server to find a new transaction number that is not yet stored, and a transaction number of a payment recognized as a normal payment is stored in the linking server.

22. The method and system of claim 19, wherein a QR code band is provided to the store.

23. The method and system of claim 19, wherein, when an order is to be canceled, search the order based on a transaction number through access to the QR pay server, and cancel the order.

24. A method and a system for linking QR pay, wherein a QR pay payment app displays information including a payment number or an amount of payment in a form of barcode or QR code after payment, and a store scans the barcode or QR code from a customer's smartphone with a scanner to transmit a payment result.
